(19) United States
(12) Patent Application Publication
(10) Pub. No.: US 2008/0294303 A1
(43) Pub. Date: Nov. 27, 2008

(54) Onboard execution of flight recorder application

(75) Inventors: Lyndon Scott King, Allen Park, MI (US); Gregory Ryan Kastelan, Allen Park, MI (US)

Correspondence Address: WOOD, PHILLIPS, KATZ, CLARK & MORTIMER, 500 W. MADISON STREET, SUITE 3800, CHICAGO, IL, 60661, US

(73) Assignee: Teradyne, Inc.

(21) Appl. No.: 11/807,116

(22) Filed: May 25, 2007

(51) Int. Cl. G05B 11/01

(52) U.S. Cl. 701/3

(57) ABSTRACT

An apparatus in an example comprises an onboard controller and a flight recorder application. The onboard controller is onboard a vehicle and comprises an onboard operating system (OS). The flight recorder application is executable onboard the vehicle by the onboard operating system.

### BACKGROUND

Offboard flight recorders for vehicles such as automobiles have taken the form of offboard dedicated equipment connected by a diagnostic connector to a bus internal to the vehicle. The offboard dedicated equipment has a processor that runs a flight recorder application. On-Board Diagnostics (OBD) refers to the self-diagnostic and reporting capability of a vehicle. OBD systems give information about the condition and/or health of a vehicle to the owner and/or a repair technician. The OBD-II specification has mandated a diagnostic connector in every vehicle sold in the US after 1996. The standardized hardware interface is the J1962 connector, a female 16-pin (2×8) connector. The J1962 and/or OBD-II connector is usually located on the driver side of the passenger compartment near the center console. The J1962 and/or OBD-II connector provides a standardized fast digital communications port for real-time data and a standardized series of diagnostic trouble codes (DTCs) that allow one to identify and remedy malfunctions within the vehicle.

### DESCRIPTION OF THE DRAWINGS

Features of exemplary implementations of the invention will become apparent from the description, the claims, and the accompanying drawings in which:

FIG. 1 is a representation of an implementation of an apparatus that comprises a vehicle, one or more connectable devices, and one or more user interfaces, and illustrates a flight recorder application that may be locatable in the vehicle and/or one or more of the one or more connectable devices, and further illustrates one or more users.

FIG. 2 is an enlarged, partial representation of the vehicle and the connectable device of an implementation of the apparatus of FIG. 1, and illustrates the vehicle with a control unit and a storage device.

FIG. 3 is an enlarged, partial representation of the connectable device coupled with a first exemplary implementation of the user interface of an implementation of the apparatus of FIG. 1.

FIG. 4 is a representation of an exemplary logic flow for review of a problem with the vehicle of an implementation of the apparatus of FIG. 1.

FIG. 5 is an enlarged, partial representation of a second exemplary implementation of the user interface coupled with a control unit of the vehicle of an implementation of the apparatus of FIG. 1.

### DETAILED DESCRIPTION

Referring to the BACKGROUND section above, the offboard flight recorders are expensive in terms of complexity and/or consumption of resources. The offboard flight recorders may need: custom circuitry for monitoring the bus internal to the vehicle; custom power supply; a custom implementation of the flight recorder application; operating system (OS) software and/or drivers to handle the vehicle interface; custom physical enclosure, handling of cooling, cable strains, user interface, and the like; and/or custom cables for attachment to the J1962 and/or OBD-II connector of the vehicle.

An exemplary implementation executes a flight recorder application onboard the vehicle. Standard computer-type docking connections on the vehicle such as universal serial bus (USB) and/or wireless capabilities such as under the Bluetooth® standard are increasingly available. The vehicle comprises an onboard processor with operating system (OS), for example, in an electronic control unit (ECU) that is onboard the vehicle. The flight recorder application in an example may be locatable onboard or offboard the vehicle, with execution of the flight recorder application onboard the vehicle. An exemplary implementation comprises low-cost hardware to support user triggers. The triggers would activate a recording by the flight recorder application. The user would take the vehicle to a technician who could view the data logs to understand occurrences, conditions, and/or behavior of the vehicle around the point of activation of the trigger.

Automotive vehicles may have an onboard device running an operating system such as offered by Microsoft Corporation under the trade identifier MICROSOFT® AUTO (World Wide Web microsoft.com). A mass storage device aboard the vehicle may hold the operating system as well as applications, previously directed to infotainment facilities in the vehicle such as audio, phone, navigation, etc. An exemplary implementation serves to help in diagnosing intermittent faults in the vehicle, for example, by allowing an application to monitor the status of a set of defined signals and record them at trigger points.

An exemplary approach performs automotive flight recorder functionality onboard without the use of custom external hardware. An exemplary implementation reduces and/or avoids a requirement and/or constraint for custom leads to connect a recorder to a vehicle. An exemplary implementation reduces and/or avoids a requirement and/or constraint for custom operating system software. An exemplary implementation employs an operating system already planned, designed, implemented, and/or provided with and/or on the vehicle. An exemplary implementation reduces and/or avoids a requirement and/or constraint for custom monitoring hardware and/or functionality for the bus and/or low level drivers to monitor the bus. An exemplary implementation employs bus monitoring capabilities already planned, designed, implemented, and/or provided with and/or on the vehicle, for example, through an ECU that provides an operating system. An exemplary implementation provides and/or allows flight recording with reduction, avoidance, and/or constraint of power use and/or heat generation attributable to presence of the flight recorder application.

An exemplary implementation employs a vehicle that comprises an onboard device with an operating system, for example, capable of running third party applications. An exemplary onboard device is connected to an internal bus of the vehicle and capable of communicating with other onboard devices. An exemplary implementation stores data recorded by the other onboard devices in a storage device such as a mass storage device. An exemplary mass storage device is located in an ECU that comprises the operating system, an onboard hard drive, an onboard memory device, and/or an external and/or offboard memory device such as a universal serial bus (USB) memory device and/or stick connected to the vehicle and/or an offboard memory device wirelessly connected to the ECU. An exemplary approach loads a flight recorder application directly onto an onboard ECU. An exemplary approach runs a flight recorder application from an external device such as a USB memory device and/or stick.

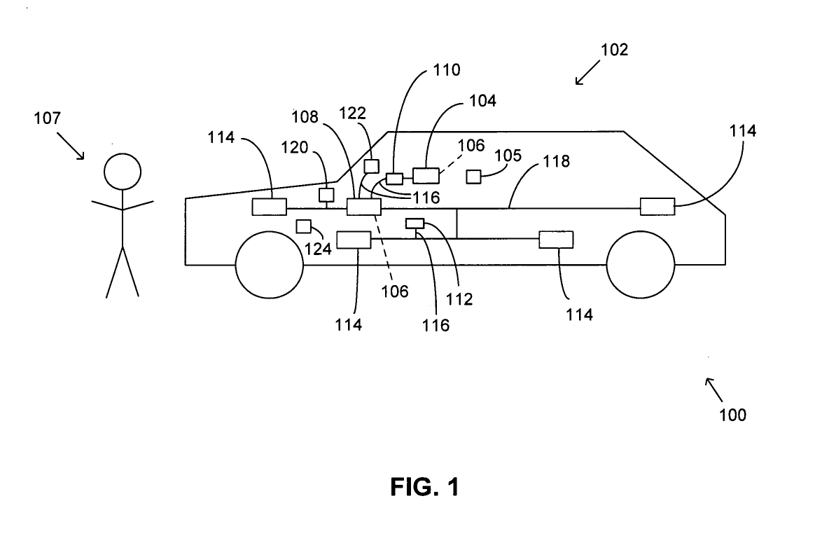

Turning to FIG. 1, an implementation of an apparatus 100 in an example comprises a vehicle 102, one or more connectable devices 104, and one or more user interfaces 105. A flight recorder application 106 in an example may be locatable in the vehicle 102 and/or one or more of the one or more connectable devices 104. An exemplary flight recorder application 106 comprises an exemplary implementation of an algorithm, procedure, program, process, mechanism, engine, model, coordinator, module, user-level application, software, code, and/or logic. One or more users 107 in an example may operate, interact, and/or appear with the vehicle. Exemplary users 107 comprise an operator and/or driver of the vehicle 102, a technician that services the vehicle 102, a passenger in the vehicle 102, and/or a person.

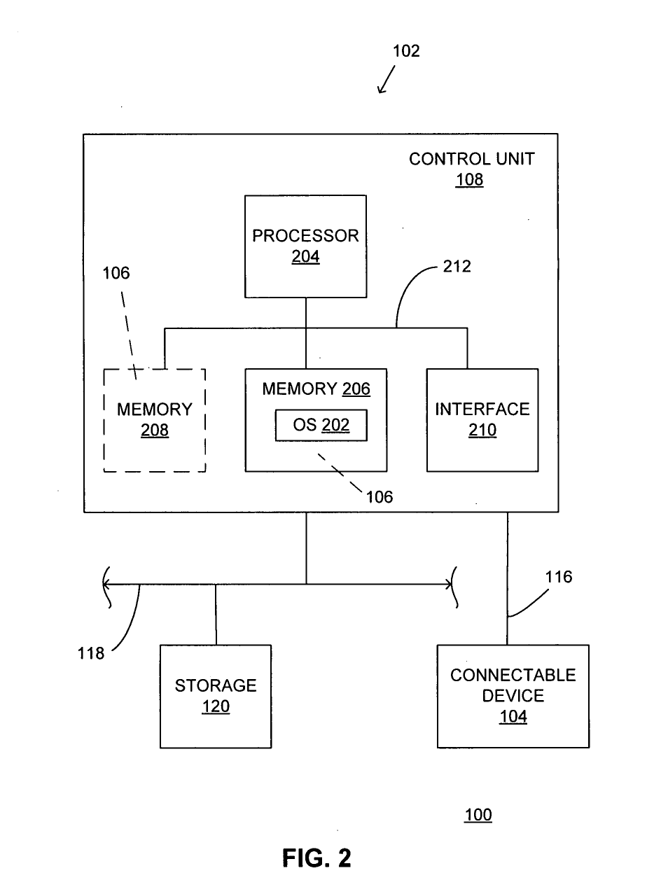

The vehicle 102 in an example comprises an automobile. The vehicle 102 in an example comprises an onboard controller and/or control unit such as an electronic control unit (ECU) 108, one or more connectors such as a universal serial bus (USB) connector 110 and/or diagnostic connector 112, one or more onboard vehicle controllers 114, one or more cables and/or leads 116, one or more busses 118, one or more storage devices 120, and/or one or more user interfaces 122. The electronic control unit 108 in an example comprises an operating system (OS) 202 (FIG. 2), for example, that is capable of running third party applications. An exemplary onboard vehicle controller 114 comprises an ECU. An ECU as the onboard vehicle controller 114 in an example omits and/or lacks an operating system that is capable of running third party applications, as an exemplary difference between an ECU as the onboard controller 114 and the electronic control unit 108.

An ECU as the electronic control unit 108 and/or one or more of the onboard vehicle controllers 114 in an example comprises an embedded system that controls one or more electrical subsystems in the vehicle 102. ECUs as the electronic control unit 108 and/or one or more of the onboard vehicle controllers 114 comprises, for example, an Engine Control Unit and/or Powertrain Control Module (PCM), Transmission Control Unit (TCU), Telephone Control Unit (TCU), Man Machine Interface (MMI), Door Control unit, Seat Control Unit, antilock brake system (ABS) controller, a stability controller, and/or Climate Control Unit.

An exemplary ECU as the electronic control unit 108 and/or one or more of the onboard vehicle controllers 114 in an example obtains and/or receives information from a sensor 124, for example, associable with one or more designated, selected, desired, measurable, defined, and/or predetermined parts, tendencies, and/or behaviors of the vehicle 102. For example, the ABS controller as the electronic control unit 108 and/or the onboard vehicle controller 114 may provide Parameter Identification (PID) values such as for the wheel speed from an exemplary sensor 124 that comprises a wheel speed sensor. An exemplary automobile as the vehicle 102 comprises ten (10) to one hundred fifty (150) ECUs as the electronic control unit 108 and/or one or more of the onboard vehicle controllers 114.

The diagnostic connector 112 in an example comprises a J1962 and/or OBD-II connector, for example, an On-Board Diagnostics (OBD) standardized hardware interface. An exemplary J1962 and/or OBD-II connector as the diagnostic connector 112 comprises a digital communications port, for example, a standardized fast port such as for real-time data. An exemplary J1962 and/or OBD-II connector as the diagnostic connector 112 communicates diagnostic trouble codes (DTCs), for example, a standardized series of codes that allow one to identify and/or remedy malfunctions within the vehicle 102.

The bus 118 in an example conforms to one or more standards and/or protocols, for example, Controller Area Network (CAN) specification, Standard Corporate Protocol (SCP), UART Based Protocol (UBP, where UART refers to Universal Asynchronous Receiver/Transmitter), ISO9141 (where the ISO trademark is associated with the International Organization for Standardization), and/or KWP2000 (KeyWord Protocol 2000). CAN comprises a broadcast, differential serial bus standard for connecting ECUs. CAN is designed to be robust in electromagnetically noisy environments. CAN may employ a differential balanced line such as RS-485. An exemplary CAN bus comprises a balanced and/or differential two-wire interface running over a shielded twisted pair (STP), unshielded twisted pair (UTP), or ribbon cable. An exemplary node employs a male nine-pin D connector. Exemplary bit encoding comprises non-return to zero (NRZ) encoding with bit-stuffing for data communication on a differential two-wire bus. NRZ encoding in an example allows compact messages with a reduced and/or minimum number of transitions and/or relatively high resilience to external disturbance.

The user interface 122 in an example comprises a touch screen, navigation screen, and/or dashboard panel device. The user interface 122 in an example is mounted, attached, and/or supported on a dashboard of the vehicle 102.

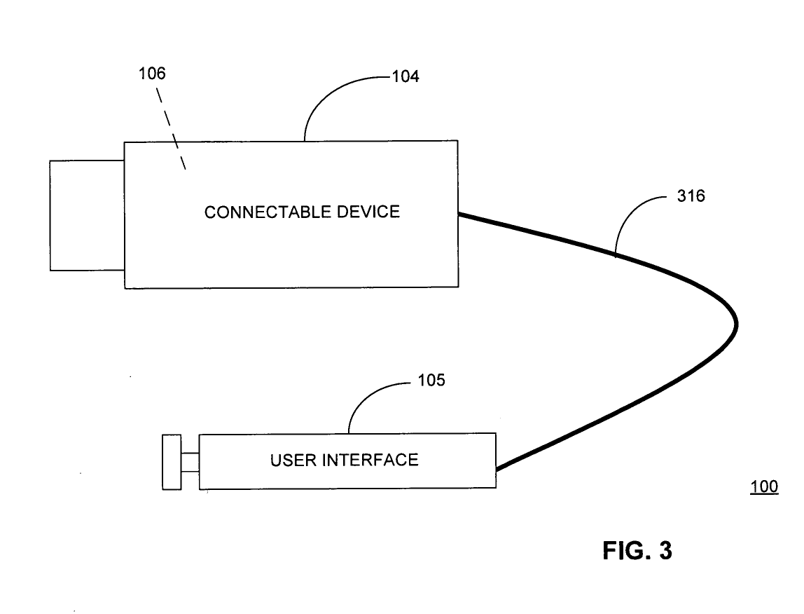

The connectable device 104 in an example comprises a storage and/or memory device, a universal serial bus (USB) and/or USB connectable device, a USB memory device and/or stick, a USB adapter, a computer-type docking connector, a hardware device, and/or a relatively low-complexity and/or low-cost device. The connectable device 104 in an example is located offboard the vehicle 102. An exemplary storage device as the connectable device 104 is capable of being loaded with the flight recorder application 106. Referring to FIGS. 1 and 3, an exemplary USB adapter as the connectable device 104 in an example serves to couple an exemplary user interface 105 with the USB connector 110. The USB connector 110 in an example comprises a standard USB interface provided on an automobile as the vehicle 107. The user 107 in an example inserts or removes the USB adapter as the connectable device 104 into a port and/or slot as the USB connector 110, for example, at selection, discretion, and/or desire of the user 107.

Turning to FIG. 2, the electronic control unit 108 in an example comprises a processor 204, one or more memories 206 and/or 208, interface 210, and/or one or more busses 212. The operating system (OS) 202 in an example is located in the memory 206. The operating system 202 in an example supports execution of the flight recorder application 106 onboard the vehicle 102 by the processor 204. The operating system 202 in an example comprises an operating system offered by Microsoft Corporation under the trade identifier MICROSOFT AUTO (World Wide Web microsoft.com). The operating system 202 in an example serves to promote diagnosis of intermittent faults in the vehicle 102, for example, by allowing an exemplary flight recorder application 106 to monitor a status of a set of defined signals connected with operation and/or state of the vehicle 102 and/or record the set of signals at trigger points. The trigger points in an example comprise one or more detected and/or measured conditions, for example, a signal reaching a threshold such as for Parameter Identification (PID), a specific Diagnostic Trouble Code (DTC) being raised, and/or the user 107 performing a selected and/or predefined action, for example, an operator as the user 107 presses a trigger button and/or touches a point on a navigation screen as an exemplary user interface 105.

The memory 206 in an example comprises a mass storage device capable of being loaded with the operating system 202. The memory 206 in an example is capable of being loaded with the flight recorder application 106. The operating system 202 in an example locally executes the flight recorder application 106 from the memory 206. A mass storage device as the memory 206 in an example holds the operating system 202, the flight recorder application 106, and one or more additional applications, for example, audio, phone, navigation, and/or the like.

The interface 210 in an example allows an operator as the user 107 to initiate and/or trigger a recording, such as through employment of the onboard vehicle controllers 114. The interface 210 in an example comprises a hardwired and/or wireless interface. A hardwired interface as the interface 210 in an example comprises a USB port. A wireless interface as the interface 210 in an example comprises a transmitter/receiver. The interface 210 in an example allows a technician as the user 107 to extract and/or access data from the memory 206 stored through employment of the flight recorder application 106. In another example, a technician as the user 107 extracts and/or accesses data from the storage device 120.

A transmitter/receiver of a wireless interface as the interface 210 in an example conforms to a standard such as a Bluetooth® standard. An exemplary standard allows intelligent devices to communicate with each other, for example, over relatively short range wireless links and/or with relatively low power consumption. The Bluetooth® standard in an example employs short-range radio frequency (RF) technology that operates at 2.4 GHz and is capable of transmitting voice and data. An exemplary effective range of devices under the Bluetooth® standard comprises thirty-two (32) feet (10 meters). An exemplary data transfer rate under the Bluetooth® standard comprises one (1) Mbps (megabits per second). Relatively low power consumption under the standard in an example allows relatively extended operation for battery powered devices, for example, wireless and/or cell phones, personal digital assistants (PDAs), and/or Internet tablets.

The memory 208 in an example comprises a mass storage device capable of being loaded with the flight recorder application 106. The operating system 202 in an example executes the flight recorder application 106 from the memory 208. The interface 210 in an example allows a technician to extract and/or access data from the 206 stored through employment of the flight recorder application 106. The memories 206 and 208 may be located on different storage devices or a same storage device, for example, in different partitions and/or non-contiguous memory locations. The memory 208 in an example is considered non-local to memory locations that store the operating system 202. For example, an exemplary flight recorder application 106 located in the memory 208 may be considered non-local to memory locations of the memory 206 that store the operating system 202, as an exemplary difference between the memory 208 and the memory 206.

The operating system 202 in an example executes the flight recorder application 106 from memory of the connectable device 104. The connectable device 104 is connected with the vehicle 102 through the lead 116 to allow the processor 204 and the operating system 202 to execute the flight recorder application 106 from the memory of the connectable device 104. The universal serial bus (USB) connector 110 in an example serves to couple the connectable device 104 with bus 116 of the vehicle 102.

Referring to FIGS. 1 and 3, an exemplary USB adapter as the connectable device 104 in an example serves to couple an exemplary user interface 105 with the USB connector 110. The user interface 105 in an example comprises a trigger coupled with the USB connector 110, for example, through employment of a cable and/or lead 316 such as a flying lead. An exemplary trigger as the user interface 105 comprises a button and/or switch that the user 107 depresses and/or engages such as with a finger of the user 107. The trigger as the user interface 105 in an example allows the user 107 to operate the trigger and activate a recording by the flight recorder application 106. A flying lead as the lead 316 attached to a USB stick as the connectable device 104 in an example serves to couple a trigger component and/or device as the user interface 105. The operator as a user 107 in an example operates the trigger as the user interface 105 such as when the operator as the user 107 senses, perceives, identifies, and/or detects an intermittent issue, problem, fault, condition, and/or behavior of the vehicle 102. Pressing of the trigger as the user interface 105 in an example serves to cause the flight recorder application 106 to effect, cause, direct, and/or provide a recording such as through employment of ECUs as the onboard vehicle controllers 114.

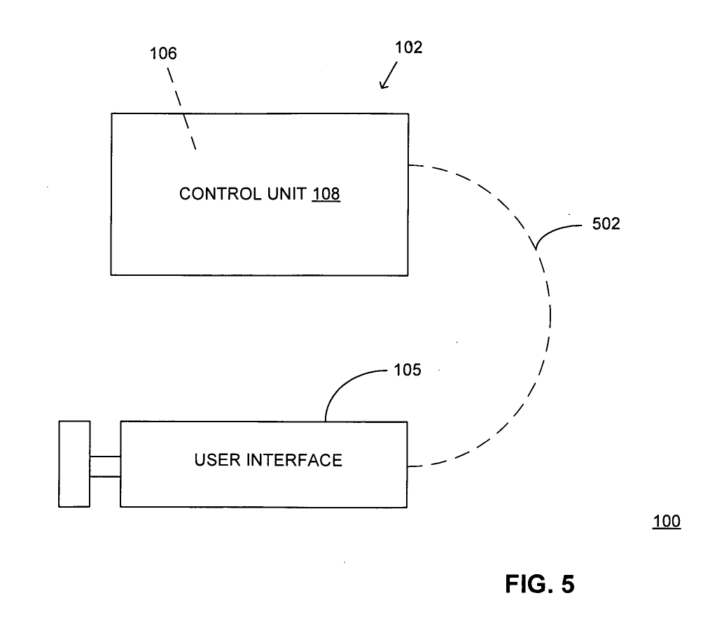

Turning to FIG. 5, user interface 105 in an example comprises a wireless trigger that communicates with the electronic control unit 108 over a wireless interface 502. The wireless interface 502 in an example serves to carry electromagnetic waves. A wireless trigger as the user interface 105 in an example comprises a wireless phone and/or communication device. A wireless trigger as the user interface 105 and the electronic control unit 108 in an example conform to a standard such as the Bluetooth® standard.

A driver as a first user 107 in an example takes the vehicle 102 to a technician as a second user 107. The technician as the user 107 in an example views information and/or data logs stored by the recorder application 106, for example, to identify and/or understand one or more occurrences, conditions, and/or behaviors of the vehicle 102 around the point of activation of the trigger. The technician as the user 107 in an example accesses a USB memory stick as the connectable device 104 that is attachable to the vehicle 102, for example, through employment of a standard USB interface as the USB connector 110.

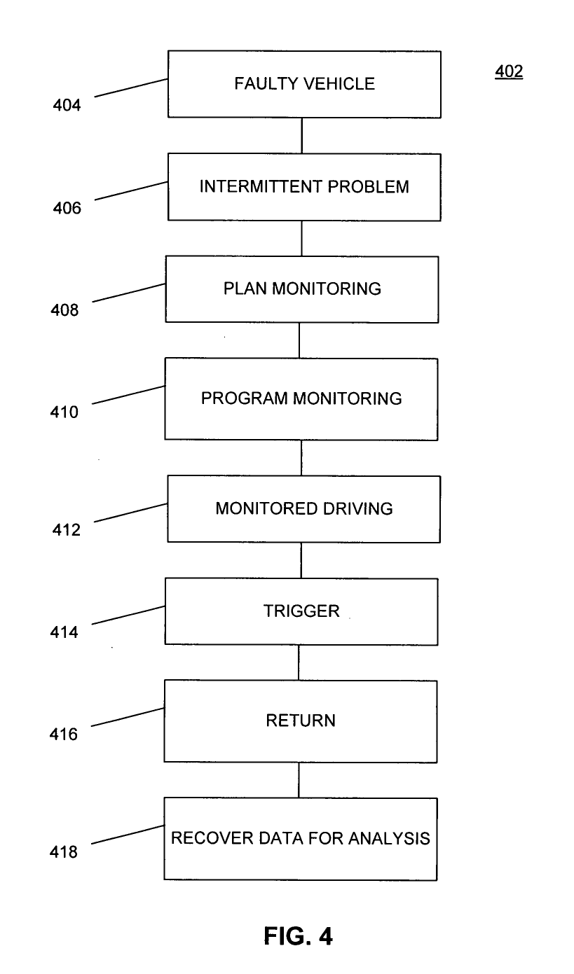

An illustrative description of an exemplary operation of an implementation of the apparatus 100 is presented, for explanatory purposes. Turning to FIG. 4, in an exemplary logic flow 402 at STEP 404, an operator as a user 107 takes a vehicle 102 for review and/or diagnosis such as by a technician as a user 107, for example, at a service center and/or station, garage, and/or shop (not shown) such as because the vehicle is exhibiting and/or experiencing faulty operation. At STEP 406 in an example the technician as the user 107 makes a determination that the vehicle 102 comprises an intermittent issue, problem, fault, condition, and/or behavior. For example, the technician as the user 107 in a selected, limited, initial, and/or preliminary amount of time, testing, and/or operation fails to and/or cannot reproduce an issue with the vehicle 102, for example, to meet and/or resemble an issue described and/or relayed by the operator as a user 107 of the vehicle. At STEP 408 in an example the technician as the user 107 plans, identifies, and/or determines one or more signals that should be monitored, one or more trigger levels and/or conditions, and/or one or more times for pre-recording and/or post-recording, for example, by and/or through employment of the flight recorder application 106. A technician as a user 107 in an example may employ one or more signal value thresholds for Parameter Identification (PID) and/or an occurrence and/or appearance of one or more Diagnostic Trouble Codes (DTCs) as a trigger for monitoring and/or recording.

At STEP 410 in an example the technician as the user 107 programs the signals to be monitored and/or trigger conditions into the flight recorder application 106. The technician as the user 107 in an example programs the signals to be monitored and/or trigger conditions into the flight recorder application 106 on the vehicle 102 or off the vehicle 102, for example, for execution of the flight recorder application 106 with execution onboard the vehicle 102 of the signals to be monitored and/or trigger conditions. The technician as the user 107 in an example programs the signals to be monitored and/or trigger conditions into the flight recorder application 106 on the electronic control unit 108 or on the connectable device 104, for example, with execution onboard the vehicle 102 of the flight recorder application 106 to handle and/or oversee the signals to be monitored and/or trigger conditions.

Through input to the flight recorder application 106 by the technician as the user 107 at STEP 410 in an example signals are selected and/or predetermined to be monitored over a monitoring time for capture of data as recordings of the vehicle 102. The technician as the user 107 at STEP 410 in an example determines and/or sets up pre-trigger and post-trigger recording times for the flight recorder application 106.

A number and/or all of the control unit 108 and the onboard vehicle controllers 114 in an example comprise a respective ECU that is capable of responding to PID requests, for example, a pre-selected, selected, predetermined, and/or determined set of PID requests. For example, the ABS controller as the electronic control unit 108 and/or the onboard vehicle controller 114 may provide Parameter Identification (PID) values such as for the wheel speed from a sensor 124, for example, a wheel speed sensor. The flight recorder application 106 in an example may request as the electronic control unit 108 and/or the onboard vehicle controller 114 an ABS controller to display the speed of the vehicle 102, a Transmission Control Unit (TCU) to select correct and/or desired gearing for the vehicle 102, a stability controller to determine whether a corner is being taken or one of the wheels of the vehicle 102 is slipping, and/or the like. The flight recorder application 106 in an example makes analogous and/or substantially same inquiries to recover, obtain, and/or record information in response to PIDs, for example, requested by the technician as the user 107 such as through pre-selected input and/or pre-selected programming of the flight recorder application 106, for example, during a visit and/or stop of the vehicle 102 at a service center and/or station, garage, and/or shop (not shown).

At STEP 412 in an example the technician as a user 107 releases the vehicle 102 to the operator as a user 107, for example, for normal, regular, usual, and/or typical driving with the monitoring having been loaded into the flight recorder application 106. At STEP 414 in an example the operator as the user 107 may trigger a recording by the flight recorder application 106. The operator as the user 107 in an example employs a trigger device as the user interface 105 and/or a dashboard panel device and/or touch screen as the user interface 122. The operator as the user 107 in an example triggers the recording upon sensing, perceiving, identifying, and/or detecting the intermittent issue, problem, fault, condition, and/or behavior of the vehicle 102.

Further at STEP 414 in an example a technician as a user 107 may employ one or more value thresholds for Parameter Identification (PID) and/or an occurrence and/or appearance of one or more Diagnostic Trouble Codes (DTCs) as a trigger for monitoring and/or recording. The flight recorder application 106 at STEP 414 in an example timestamps each reading and/or recording, for example, to promote accuracy such as in rendering of the data at STEP 418 for review by a technician as the user 107. The flight recorder application 106 in an example records a type of trigger that causes a recording and/or a time of the trigger within and/or during the recording.

At STEP 416 in an example the operator as the first user 107 returns the vehicle 102 to the technician as the second user 107 at a selected, scheduled, arbitrary, and/or convenient after a period and/or amount of driving and/or operation of the vehicle 102 and/or recording through employment of the flight recorder application 106. At STEP 418 in an example the technician as the user 107 recovers data recorded by the flight recorder application 106, for example, through employment of ECUs as the onboard vehicle controllers 114. The technician as the user 107 in an example performs, directs, and/or oversees analysis of the data effected, caused, directed, and/or provided from and/or through employment of the flight recorder application 106. The technician as the user 107 in an example obtains, receives, retrieves, and/or downloads the data from the electronic control unit 108, the connectable device 104, and/or the storage device 120.

The technician as the user 107 at STEP 418 in an example reviews the recordings, for example, recordings of the conditions of the vehicle 102 before and after a trigger point. The recordings in an example comprise captured data of the signals that were selected and/or predetermined to be monitored over a monitoring time, for example, through input to the flight recorder application 106 by the technician as the user 107 such as at STEP 410. The technician as the user 107 at STEP 410 in an example predetermined, selected, and/or set up pre-trigger and post-trigger recording times for the flight recorder application 106. An amount of data recorded at STEP 414, returned at STEP 416, and/or recovered at STEP 418 in an example may depend on a capture rate and a number of signals identified for monitoring.

An exemplary implementation comprises an onboard controller and a flight recorder application. The onboard controller is onboard a vehicle and comprises an onboard operating system (OS). The flight recorder application is executable onboard the vehicle by the onboard operating system.

The onboard controller comprises an electronic control unit (ECU). The flight recorder application accesses one or more onboard vehicle controllers through onboard execution of the flight recorder application by the onboard operating system. The onboard controller through execution of the flight recorder application onboard the vehicle by the onboard operating system stores data recorded by one or more onboard vehicle controllers in a mass storage device. The onboard controller comprises an onboard memory device. The mass storage device comprises one or more of the onboard memory device of the onboard controller, an onboard hard drive that is onboard the vehicle, an onboard memory device that is onboard the vehicle, and/or a connectable memory device that is connectable with the vehicle through an interface of the vehicle. The onboard controller is coupled with an internal bus of the vehicle. The flight recorder application accesses one or more onboard vehicle controllers over the internal bus of the vehicle through onboard execution of the flight recorder application by the onboard operating system.

The flight recorder application comprises an onboard flight recorder application that is stored onboard the vehicle. The onboard operating system supports onboard execution of the onboard flight recorder application. The onboard controller comprises an electronic control unit (ECU). An onboard storage device is local to the onboard operating system. The onboard flight recorder application is stored in the onboard storage device that is local to the onboard operating system. The onboard flight recorder application that is stored in the onboard storage device that is local to the onboard operating system accesses one or more onboard vehicle controllers through onboard execution of the onboard flight recorder application by the onboard operating system.

The onboard controller comprises an electronic control unit (ECU). An onboard storage device is separate from the onboard operating system. The onboard flight recorder application is stored in the onboard storage device that is separate from the onboard operating system. The onboard flight recorder application that is stored in the onboard storage device that is separate from the onboard operating system accesses one or more onboard vehicle controllers through onboard execution of the onboard flight recorder application by the onboard operating system.

The flight recorder application is stored in a connectable device that is connectable with the onboard processor and supportable by the onboard operating system for execution onboard the vehicle of the flight recorder application by the onboard operating system. The onboard controller comprises an electronic control unit (ECU). Upon a connection of the connectable device with the onboard operating system the flight recorder application that is stored in the connectable device accesses one or more onboard vehicle controllers through onboard execution of the flight recorder application stored in the connectable device, by virtue of support by the onboard operating system of the onboard execution of the flight recorder application by the onboard operating system. The connectable device is connected with the onboard processor through a universal serial bus (USB) connection. The flight recorder application that is stored in the connectable device accesses one or more onboard vehicle controllers through onboard execution of the flight recorder application stored in the connectable device connected through the USB connection, by virtue of support by the onboard operating system of the onboard execution of the flight recorder application by the onboard operating system.

An exemplary implementation comprises a flight recorder application that is executed by an onboard operating system (OS) that is onboard a vehicle. The flight recorder application assists diagnosis of one or more intermittent faults in the vehicle. The flight recorder application monitors a status of a set of technician-selected, pre-defined signals that relate to real-time sensor and/or actuator values stored in one or more electronic control units (ECUs). The flight recorder application records a set of signal triggers selected by a technician subsequent to an identification by an operator of the vehicle of the one or more intermittent faults in the vehicle. The set of signal triggers comprise a user trigger that is invocable by one or more of: the operator of the vehicle upon experience of a condition of concern; a sensor read of parameter identification (PID) value that reaches or exceeds a technician-defined level; and/or an onboard controller that raises a diagnostic trouble code (DTC). Upon a recurrence of one or more of the one or more intermittent faults in the vehicle and/or an occurrence of one or more other intermittent faults in the vehicle, one or more of the same set of signal triggers and/or one or more other signal triggers are selectable by the technician.

The flight recorder application is located any of onboard the vehicle or offboard the vehicle with a connection to the operating system. The flight recorder application is executed onboard the vehicle by the operating system that is located onboard the vehicle whether the flight recorder application is located onboard the vehicle or offboard the vehicle with the connection to the operating system. Indicated in the flight recorder application located any of onboard the vehicle or offboard the vehicle with the connection to the operating system are one or more signals to be monitored onboard the vehicle and/or one or more trigger conditions to be executed onboard the vehicle. The flight recorder application is executed onboard the vehicle by the operating system to monitor the one or more signals onboard the vehicle and/or execute the one or more trigger conditions onboard the vehicle.

Indicated in the flight recorder application located any of onboard the vehicle or offboard the vehicle with the connection to the operating system is a request for a performance of a recording through employment of one or more onboard vehicle controllers based on a perception of an occurrence of an intermittent event. The flight recorder application is executed onboard the vehicle by the operating system to execute onboard the vehicle the performance of the recording through employment of the one or more onboard vehicle controllers. The flight recorder application is executed onboard the vehicle by the operating system to execute onboard the vehicle a storage, any of onboard the vehicle or offboard the vehicle, of data obtained through employment of the one or more onboard vehicle controllers in the performance of the recording.

An implementation of the apparatus 100 in an example comprises a plurality of components such as one or more of electronic components, chemical components, organic components, mechanical components, hardware components, optical components, and/or computer software components. A number of such components can be combined or divided in an implementation of the apparatus 100. In one or more exemplary implementations, one or more features described herein in connection with one or more components and/or one or more parts thereof are applicable and/or extendible analogously to one or more other instances of the particular component and/or other components in the apparatus 100. In one or more exemplary implementations, one or more features described herein in connection with one or more components and/or one or more parts thereof may be omitted from or modified in one or more other instances of the particular component and/or other components in the apparatus 100. An exemplary technical effect is one or more exemplary and/or desirable functions, approaches, and/or procedures. An exemplary component of an implementation of the apparatus 100 employs and/or comprises a set and/or series of computer instructions written in or implemented with any of a number of programming languages, as will be appreciated by those skilled in the art. An implementation of the apparatus 100 in an example comprises any (e.g., horizontal, oblique, angled, or vertical) orientation, with the description and figures herein illustrating an exemplary orientation of an exemplary implementation of the apparatus 100, for explanatory purposes.

An implementation of the apparatus 100 in an example encompasses an article. The article comprises one or more computer-readable signal-bearing media. The article comprises means in the one or more media for one or more exemplary and/or desirable functions, approaches, and/or procedures.

An implementation of the apparatus 100 in an example employs one or more computer readable signal bearing media. A computer-readable signal-bearing medium in an example stores software, firmware and/or assembly language for performing one or more portions of one or more implementations. An example of a computer-readable signal bearing medium for an implementation of the apparatus 100 comprises a memory and/or recordable data storage medium of the vehicle 102, connectable device 104, onboard controller and/or electronic control unit (ECU) 108, and/or storage device 120. A computer-readable signal-bearing medium for an implementation of the apparatus 100 in an example comprises one or more of a magnetic, electrical, optical, biological, chemical, and/or atomic data storage medium. For example, an implementation of the computer-readable signal-bearing medium comprises one or more floppy disks, magnetic tapes, CDs, DVDs, hard disk drives, and/or electronic memory. In another example, an implementation of the computer-readable signal-bearing medium comprises a modulated carrier signal transmitted over a network comprising or coupled with an implementation of the apparatus 100, for instance, one or more of a telephone network, a local area network (“LAN”), a wide area network (“WAN”), the Internet, and/or a wireless network. A computer-readable signal-bearing medium in an example comprises a physical computer medium and/or computer-readable signal-bearing tangible medium.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
an onboard controller that is onboard a vehicle and comprises an onboard operating system (OS); and
a flight recorder application that is executable onboard the vehicle by the onboard operating system.

2. The apparatus of claim 1, wherein the onboard controller comprises an electronic control unit (ECU), wherein the flight recorder application accesses one or more onboard vehicle controllers through onboard execution of the flight recorder application by the onboard operating system.

3. The apparatus of claim 1, wherein the onboard controller through execution of the flight recorder application onboard the vehicle by the onboard operating system stores data recorded by one or more onboard vehicle controllers in a mass storage device.

4. The apparatus of claim 3, wherein the onboard controller comprises an onboard memory device, wherein the mass storage device comprises one or more of the onboard memory device of the onboard controller, an onboard hard drive that is onboard the vehicle, an onboard memory device that is onboard the vehicle, and/or a connectable memory device that is connectable with the vehicle through an interface of the vehicle.

5. The apparatus of claim 1, wherein the onboard controller is coupled with an internal bus of the vehicle, wherein the flight recorder application accesses one or more onboard vehicle controllers over the internal bus of the vehicle through onboard execution of the flight recorder application by the onboard operating system.

6. The apparatus of claim 1, wherein the flight recorder application comprises an onboard flight recorder application that is stored onboard the vehicle.

7. The apparatus of claim 6, wherein the onboard operating system supports onboard execution of the onboard flight recorder application.

8. The apparatus of claim 6, wherein the onboard controller comprises an electronic control unit (ECU), the apparatus further comprising:
an onboard storage device that is local to the onboard operating system;
wherein the onboard flight recorder application is stored in the onboard storage device that is local to the onboard operating system, wherein the onboard flight recorder application that is stored in the onboard storage device that is local to the onboard operating system accesses one or more onboard vehicle controllers through onboard execution of the onboard flight recorder application by the onboard operating system.

9. The apparatus of claim 6, wherein the onboard controller comprises an electronic control unit (ECU), the apparatus further comprising:
an onboard storage device that is separate from the onboard operating system;
wherein the onboard flight recorder application is stored in the onboard storage device that is separate from the onboard operating system, wherein the onboard flight recorder application that is stored in the onboard storage device that is separate from the onboard operating system accesses one or more onboard vehicle controllers through onboard execution of the onboard flight recorder application by the onboard operating system.

10. The apparatus of claim 1, wherein the flight recorder application is stored in a connectable device that is connectable with the onboard processor and supportable by the onboard operating system for execution onboard the vehicle of the flight recorder application by the onboard operating system.

11. The apparatus of claim 10, wherein the onboard controller comprises an electronic control unit (ECU), wherein upon a connection of the connectable device with the onboard operating system the flight recorder application that is stored in the connectable device accesses one or more onboard vehicle controllers through onboard execution of the flight recorder application stored in the connectable device, by virtue of support by the onboard operating system of the onboard execution of the flight recorder application by the onboard operating system.

12. The apparatus of claim 10, wherein the onboard controller comprises an electronic control unit (ECU), wherein the connectable device is connected with the onboard processor through a universal serial bus (USB) connection, wherein the flight recorder application that is stored in the connectable device accesses one or more onboard vehicle controllers through onboard execution of the flight recorder application stored in the connectable device connected through the USB connection, by virtue of support by the onboard operating system of the onboard execution of the flight recorder application by the onboard operating system.

13. An apparatus, comprising:
a flight recorder application that is executed by an onboard operating system (OS) that is onboard a vehicle;
wherein the flight recorder application assists diagnosis of one or more intermittent faults in the vehicle.

14. The apparatus of claim 13, wherein the flight recorder application monitors a status of a set of technician-selected, pre-defined signals that relate to real-time sensor and/or actuator values stored in one or more electronic control units (ECUs).

15. The apparatus of claim 13, wherein the flight recorder application records a set of signal triggers selected by a technician subsequent to an identification by an operator of the vehicle of the one or more intermittent faults in the vehicle, wherein the set of signal triggers comprise a user trigger that is invocable by one or more of:
the operator of the vehicle upon experience of a condition of concern;
a sensor read of parameter identification (PID) value that reaches or exceeds a technician-defined level; and/or
an onboard controller that raises a diagnostic trouble code (DTC);
wherein upon a recurrence of one or more of the one or more intermittent faults in the vehicle and/or an occurrence of one or more other intermittent faults in the vehicle, one or more of the same set of signal triggers and/or one or more other signal triggers are selectable by the technician.

16. A method, comprising the step of:
executing onboard a vehicle a flight recorder application by an operating system that is located onboard the vehicle.

17. The method of claim 16, wherein the step of executing onboard the vehicle the flight recorder application comprises the steps of:
locating the flight recorder application any of onboard the vehicle or offboard the vehicle with a connection to the operating system; and
executing onboard the vehicle the flight recorder application by the operating system that is located onboard the vehicle whether the flight recorder application is located onboard the vehicle or offboard the vehicle with the connection to the operating system.

18. The method of claim 16, wherein the step of executing onboard the vehicle the flight recorder application comprises the steps of:
locating the flight recorder application any of onboard the vehicle or offboard the vehicle with a connection to the operating system;
indicating in the flight recorder application located any of onboard the vehicle or offboard the vehicle with the connection to the operating system one or more signals to be monitored onboard the vehicle and/or one or more trigger conditions to be executed onboard the vehicle; and
executing onboard the vehicle the flight recorder application by the operating system to monitor the one or more signals onboard the vehicle and/or execute the one or more trigger conditions onboard the vehicle.

19. The method of claim 16, wherein the step of executing onboard the vehicle the flight recorder application comprises the steps of:
locating the flight recorder application any of onboard the vehicle or offboard the vehicle with a connection to the operating system;
indicating in the flight recorder application located any of onboard the vehicle or offboard the vehicle with the connection to the operating system a request for a performance of a recording through employment of one or more onboard vehicle controllers based on a perception of an occurrence of an intermittent event; and
executing onboard the vehicle the flight recorder application by the operating system to execute onboard the vehicle the performance of the recording through employment of the one or more onboard vehicle controllers.

20. The method of claim 19, wherein the step of executing onboard the vehicle the flight recorder application by the operating system to execute onboard the vehicle the performance of the recording through employment of the one or more onboard vehicle controllers comprises the step of:
executing onboard the vehicle the flight recorder application by the operating system to execute onboard the vehicle a storage, any of onboard the vehicle or offboard the vehicle, of data obtained through employment of the one or more onboard vehicle controllers in the performance of the recording.
